(19) United States
(12) Patent Application Publication
(10) Pub. No.: US 2025/0043388 A1
(43) Pub. Date: Feb. 6, 2025

(54) METHOD FOR RECOVERY OF SILVER IONS FROM AQUEOUS COMPOSITIONS

(71) Applicant: KING FAHD UNIVERSITY OF PETROLEUM AND MINERALS, Dhahran (SA)

(72) Inventors: Ismail ABDULAZEEZ, Dhahran (SA); Othman Charles S. AL-HAMOUZ, Dhahran (SA); Isam ALJUNDI, Dhahran (SA)

(73) Assignee: KING FAHD UNIVERSITY OF PETROLEUM AND MINERALS, Dhahran (SA)

(21) Appl. No.: 18/362,262

(22) Filed: Jul. 31, 2023

(51) Int. Cl. C22B 11/00; C22B 7/00

(52) U.S. Cl. CPC C22B 11/042; C22B 7/006

(57) ABSTRACT

A method for recovering metals includes mixing AC5 with a first solution comprising at least one metal ion to produce an AC5-metal ion complex. The method includes separating the AC5-metal ion complex from a second solution. The method further includes regenerating AC5 by dissociating the at least one metal ion from the AC5-metal ion complex. AC5 is a tris-benzo-15-crown-5 compound.

### BACKGROUND

### Technical Field

The present disclosure is directed to a method for recovering metals, and particularly, to the method for recovering silver metal using a crown-based material.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

The demand for silver has been on the rise over the years due to its use in jewelry, coins, medical equipment, and in the production of electronic components. Its high conductivity, malleability, ductility, and resistance to corrosion make it a valuable metal in the manufacturing industries. In fact, silver is an indispensable metal whose mining dates to 3000 BCE and continues to evolve. According to the United States Geological Survey (USGS), the total world silver reserves are estimated to be 570,000 tons, the majority of which comes from mines, while the rest is recovered from recycled materials. While the earth's silver reserves are continuously being depleted, there is a need to explore alternative sources of the precious metal, such as the ocean and from recycled electronic wastes.

The ocean and e-wastes are two important sources of silver ions which, when properly harnessed, could complement the existing mining technologies and help conserve land-based resources. While the concentration of silver in seawater is extremely low (<1 ppm), the vast volume of seawater makes it an inexhaustible source of precious metal. Consequently, the total silver reserve in the ocean is estimated at approximately 17 million metric tons (over 7 times greater than those found on land). E-waste, on the other hand, is a common source of precious metals such as gold, silver, platinum, and palladium, which, if not properly disposed of, could constitute various environmental hazards. The recovery of these metals from e-waste is thus critical as it not only helps to conserve scarce resources but also reduces the environmental impacts of e-waste disposal. Despite the abundance of silver in the ocean and in recycled e-wastes, the presence of competing metal ions makes the recovery extremely challenging. Under these circumstances, the design of materials that selectively recovers silver with minimal interference from the competing ions is highly desired.

Among the materials exploited for this purpose are crown ethers (CEs), whose unique host-guest complex formation tendency has been utilized for the recovery of several metal ions [B. Martinez-Haya, P. Hurtado, A. R. Hortal, S. Hamad, J. D. Steill, J. Oomens, Emergence of Symmetry and Chirality in Crown Ether Complexes with Alkali Metal Cations, The Journal of Physical Chemistry A 114(26) (2010) 7048-7054; A. Datta, Role of Metal Ions (M=Li+, Na+, and K+) and Pore Sizes (Crown-4, Crown-5, and Crown-6) on Linear and Nonlinear Optical Properties: New Materials for Optical Birefringence, The Journal of Physical Chemistry C 113(8) (2009) 3339-3344]. The ion-dipole interaction with metal ions often drives the formation of the crown-metal complexes, whose stability has been attributed to the cation charge and size, the macrocyclic pore size, and the nature of the solvating medium [A. Datta, Role of Metal Ions (M=Li+, Na+, and K+) and Pore Sizes (Crown-4, Crown-5, and Crown-6) on Linear and Nonlinear Optical Properties: New Materials for Optical Birefringence, The Journal of Physical Chemistry C 113(8) (2009) 3339-3344]. Several studies on the use of CEs as recovery agents of silver ions have been reported. Paul et al. [I. Paul, N. Mittal, S. De, M. Bolte, M. Schmittel, Catch-Release System for Dosing and Recycling Silver(I) Catalyst with Status of Catalytic Activity Reported by Fluorescence, Journal of the American Chemical Society 141(13) (2019) 5139-5143] reported the catch-release fluorescent dosing and recycling of silver ions on an anthracene-appended CE and demonstrated the practical utilization of such systems in molecular communication. Falaki and co-workers [F. Falaki, M. Shamsipur, F. Shemirani, Simultaneous selective separation of silver (I) and lead (II) ions from a single dilute source solution through two supported liquid membranes composed of selective crown ethers in supra molecular solvent, Chemical Papers 75(10) (2021) 5489-5502] reported the selective recovery of silver and lead ions from single stream solutions on supported liquid membranes loaded with 18-crown-6 materials.

The extraction of silver, cesium, strontium, and other metal ions in fluorinated diluents containing CEs was reported by Smirnov et al. [IV. Smirnov, M. D. Karavan, E. V. Kenf, L. I. Tkachenko, V. V. Timoshenko, A. A. Brechalov, T. V. Maltseva, Y. E. Ermolenko, Extraction of Cesium, Strontium, and Stable Simulated HLW Components with Substituted Crown Ethers in New Fluorinated Diluents, Solvent Extraction and Ion Exchange 40(7) (2022) 756-776]. Fissaha and co-workers [H. T. Fissaha, G. M. Nisola, F. K. Burnea, J. Y. Lee, S. Koo, S.-P. Lee, K. Hem, W.-J. Chung, Synthesis and application of novel hydroxylated thia-crown ethers as composite ionophores for selective recovery of Ag+ from aqueous sources, Journal of Industrial and Engineering Chemistry 81 (2020) 415-426] demonstrated the recovery of silver ions on hydroxylated thio-CEs with various cavity sizes and achieved excellent uptake of 124-179 mg/g within 24 h.

While the thia-CEs have achieved remarkable results, their complex synthesis protocol and the time required to achieve maximum uptake makes them impractical for real analysis where abundant competing ions co-exist. Others are; the use of crown-functionalized mesoporous silica [M. Hong, X. Wang, W. You, Z. Zhuang, Y. Yu, Adsorbents based on crown ether functionalized composite mesoporous silica for selective extraction of trace silver, Chemical Engineering Journal 313 (2017) 1278-1287], crown-based supramolecular nanostructures [Z.-Y. Zhang, Y. Chen, Y. Zhou, Y. Liu, Tunable Supramolecular Nanoarchitectures Constructed by the Complexation of Diphenanthro-24-Crown-8/Cesium(I) with Nickel(II) and Silver(I) Ions, 84(2) (2019) 161-165; Q.-X. Geng, F. Wang, H. Cong, Z. Tao, G. Wei, Recognition of silver cations by a cucurbit[8]uril-induced supramolecular crown ether, Organic & Biomolecular Chemistry 14(8) (2016) 2556-2562; W.-M. Wang, D. Dai, J.-R. Wu, C. Wang, Y. Wang, Y.-W. Yang, Renewable supramolecular assembly-induced emission enhancement system for efficient detection and removal of silver(I), Dyes and Pigments 207 (2022) 110712], aza-crown grafted heterocycles [I. Takashima, A. Kanegae, M. Sugimoto, A. Ojida, Aza-Crown-Ether-Appended Xanthene: Selective Ratiometric Fluorescent Probe for Silver(I) Ion Based on Arene-Metal Ion Interaction, Inorganic Chemistry 53(14) (2014) 7080-7082] and the use of polymeric sensors [P. A. Panchenko, Y. V. Fedorov, A. S. Polyakova, O. A. Fedorova, Fluorimetric detection of Ag+ cations in aqueous solutions using a polyvinyl chloride sensor film doped with crown-containing 1,8-naphthalimide, Mendeleev Communications 31(4) (2021) 517-519].

Despite their numerous potentials, CEs suffer from tremendous interference from co-existing metal ions in e-waste, lowering their selectivity. Moreover, since according to the hard-soft acid-base (HSAB) principle proposed by Pearson [R. G. Pearson, Absolute electronegativity and hardness: application to inorganic chemistry, Inorganic Chemistry 27(4) (1988) 734-740], the hard Lewis base CEs would bind strongly to hard alkali metal ions present in seawater, consequently blocking the adsorption sites. Therefore, there exists a need to develop method to recover metals, particularly silver, that overcomes the drawbacks in the art.

Accordingly it is one object of the present disclosure to provide a method for recovering metals such as silver from complex matrices such as seawater and e-waste.

### SUMMARY

In an exemplary embodiment, a method for recovering metals is described. The method includes mixing AC5 with a first solution including at least one metal ion to produce an AC5-metal ion complex. The method includes separating the AC5-metal ion complex from a second solution. The method includes regenerating AC5 by dissociating the at least one metal ion from the AC5-metal ion complex. AC5 is a tris-benzo-15-crown-5 compound.

In some embodiments, the tris-benzo-15-crown-5 compound includes at least one Schiff base bridge.

In some embodiments, the tris-benzo-15-crown-5 compound is tris(4-methylbenzyl-4′aminobenzo-15-crown-5 ether)amine.

In some embodiments, the at least one metal ion is silver.

In some embodiments, the first solution is sea water.

In some embodiments, the first solution is electronic wastewater.

In some embodiments, the tris-benzo-15-crown-5 compound has a silver ion distribution coefficient K_{d} greater than 200 liter per gram (L/g) calculated according to the following:

$${K}_{d} ( L / g ) = \frac{{C}_{o} - {C}_{e}}{{C}_{e}} \times \frac{V}{m}$$

where Cₒ, Cₑ, m, and V are the starting metal ion concentration (ppm), the equilibrium concentration of the metal ions (ppm), the mass of AC5 added (g) and the volume of the solution (ml or L).

In some embodiments, the method includes at least 5 regeneration cycles.

In some embodiments, the AC5 is regenerated by mixing a solution including dithizone, an acid, and ethanol with the AC5-metal ion complex.

In some embodiments, the acid is HCl.

In some embodiments, mixing AC5 with the first solution includes mixing the AC5 in solid form with the second solution.

In some embodiments, mixing AC5 with the first solution includes mixing a solution including the AC5 with the second solution. The solution including the AC5 is immiscible with the second solution.

In some embodiments, the solution including AC5 includes dichloromethane as a solvent.

In some embodiments, the mixing has a mixing time greater than or equal to 2 hours.

In some embodiments, the mixing time is 2 hours.

In some embodiments, the mixing includes ultrasonically mixing the AC5 and the first solution.

In some embodiments, the separation of the AC5-metal ion complex further includes filtering the AC5-metal ion complex from the second solution.

In some embodiments, at least one metal ion coordinates to the AC5 at a Φ2 or Φ3 position.

In some embodiments, the tris-benzo-15-crown-5 compound has a silver ion uptake capacity of at least 30 milligram per gram (mg/g).

In some embodiments, the first solution further includes dissolved ions Li⁺, Na⁺, K⁺, Ca²⁺, Cu²⁺, Cd²⁺, and Ni²⁺.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic flow chart of a method for recovering metals, according to certain embodiments;

FIG. 2A depicts structural geometry of benzo-15-crown-5, according to certain embodiments;

FIG. 2B depicts structural geometry of 3D 15-crown-5 Schiff base (AC5), according to certain embodiments;

FIG. 2C depicts structural geometry of hydrated Ag(H₂O)⁴⁺, according to certain embodiments;

FIG. 2D depicts structural geometry of the corresponding frontier orbital distribution of the hydrated ion, calculated at the Generalized Gradient Approximation (GGA)-PBE level of theory, according to certain embodiments;

FIG. 3A depicts frontier orbital distribution of benzo-15-crown-5, according to certain embodiments;

FIG. 3B depicts frontier orbital distribution of AC5, according to certain embodiments;

FIG. 3C depicts fundamental electronics properties of both molecules calculated at the GGA-PBE level of theory, according to certain embodiments;

FIG. 4A depicts structural geometries of the interaction of benzo-15-crown-5 with Ag⁺ ion and the corresponding frontier orbital distributions, according to certain embodiments;

FIG. 4B depicts structural geometries of the interaction of benzo-15-crown-5 with Li⁺ ion and the corresponding frontier orbital distributions, according to certain embodiments;

FIG. 4C depicts structural geometries of the interaction of benzo-15-crown-5 with Na⁺ ion and the corresponding frontier orbital distributions, according to certain embodiments;

FIG. 4D depicts structural geometries of the interaction of benzo-15-crown-5 with K⁺ion and the corresponding frontier orbital distributions, according to certain embodiments;

FIG. 4E depicts structural geometries of the interaction of benzo-15-crown-5 with Mg²⁺ ion and the corresponding frontier orbital distributions, according to certain embodiments;

FIG. 4F depicts structural geometries of the interaction of benzo-15-crown-5 with Ca²⁺ ion and the corresponding frontier orbital distributions, according to certain embodiments;

FIG. 5A depicts structural geometries of the interaction of AC5 with Ag⁺ ions at Φ₁ position and the corresponding frontier orbital distributions, according to certain embodiments;

FIG. 5B depicts structural geometries of the interaction of AC5 with Ag⁺ ions at Φ2 position and the corresponding frontier orbital distributions, according to certain embodiments;

FIG. 5C depicts structural geometries of the interaction of AC5 with Ag⁺ ions at Φ₃ position and the corresponding frontier orbital distributions, according to certain embodiments;

FIG. 6A depicts interaction energies of AC5 with the metal ions at the Φ₁ position, according to certain embodiments;

FIG. 6B depicts interaction energies of AC5 with the metal ions at the Φ2 position, according to certain embodiments;

FIG. 6C depicts interaction energies of AC5 with the metal ions at the Φ3 position, according to certain embodiments;

FIG. 7A depicts non-covalent interaction (NCI) isosurface plots of the interactions of AC5 with Ag⁺ ions at the Φ₁, position, according to certain embodiments;

FIG. 7B depicts NCI isosurface plots of the interactions of AC5 with Ag⁺ ions at the Φ₂, position, according to certain embodiments;

FIG. 7C depicts NCI isosurface plots of the interactions of AC5 with Ag⁺ ions at the Φ₃, position, according to certain embodiments;

FIG. 8A depicts partial density of states of surface atoms of AC5, according to certain embodiments;

FIG. 8B depicts interactions of AC5 with Ag⁺ ions at the Φ₁ position, according to certain embodiments;

FIG. 8C depicts interactions of AC5 with Ag⁺ ions at the Φ₂ position, according to certain embodiments;

FIG. 8D depicts interactions of AC5 with Ag⁺ ions at the Φ₃ position, according to certain embodiments;

FIG. 9A depicts mean square displacement (MSD)-t plots of the diffusion of the metal ions in seawater, according to certain embodiments;

FIG. 9B depicts a constructed amorphous simulation box, according to certain embodiments;

FIG. 9C depicts MSD-t plot of the diffusion of the metal ions in e-waste in aqueous system including AC5, according to certain embodiments;

FIG. 9D depicts an image of attraction of partially dehydrated Ag⁺ ions approaching the active center, according to certain embodiments;

FIG. 10A depicts interactions of AC5 with Ag⁺ ions at the Φ₁ position, according to certain embodiments;

FIG. 10B depicts radial distribution function (RDF) plot of the interactions of isolated and hydrated ions corresponding to FIG. 10A, according to certain embodiments;

FIG. 10C depicts interactions of AC5 with Ag⁺ ions at the Φ₂ position, according to certain embodiments;

FIG. 10D depicts RDF plot of the interactions of isolated and hydrated ions corresponding to FIG. 10C, according to certain embodiments;

FIG. 10E depicts interactions of AC5 with Ag⁺ ions at the Φ₃ position, according to certain embodiments;

FIG. 10F depicts RDF plot of the interactions of isolated and hydrated ions corresponding to FIG. 10E, according to certain embodiments;

FIG. 11A depicts an image including AC5 in powder form, according to certain embodiments;

FIG. 11B depicts scanning electron microscope (SEM) micrograph of AC5, according to certain embodiments;

FIG. 11C depicts transmission electron microscope (TEM) micrograph of AC5 at 200 nanometers (nm), according to certain embodiments;

FIG. 11D depicts TEM micrograph of AC5 at 100 nm, according to certain embodiments;

FIG. 11E depicts an elemental mapping of carbon element on the surface of AC5, according to certain embodiments;

FIG. 11F depicts an elemental mapping of nitrogen element on the surface of AC5, according to certain embodiments;

FIG. 11G depicts an elemental mapping of oxygen element on the surface of AC5, according to certain embodiments;

FIG. 12A depicts Fourier Transform Infrared (FTIR) spectra of AC5, 4′-aminobenzo-15-crown-5, tris(4-formylphenyl)amine, according to certain embodiments;

FIG. 12B depicts an X-ray Diffraction (XRD) pattern of AC5, according to certain embodiments;

FIG. 12C depicts Selected Area Electron Diffraction (SAED) spectrum of AC5, according to certain embodiments;

FIG. 12D depicts thermal gravimetric analysis (TGA) profile of AC5, according to certain embodiments;

FIG. 12E depicts elemental analysis of AC5, according to certain embodiments;

FIG. 13A depicts recovery efficiency of the metal ions present in seawater on AC5 during silver recovery from 30 parts per million (ppm) aqueous solutions, according to certain embodiments;

FIG. 13B depicts uptake capacity of the metal ions present in seawater on AC5 during silver recovery from 30 ppm aqueous solutions, according to certain embodiments;

FIG. 13C depicts distribution coefficients of the metal ions present in seawater on AC5 during silver recovery from 30 ppm aqueous solutions, according to certain embodiments;

FIG. 13D depicts silver recovery in the presence of metal ions present in e-waste, according to certain embodiments;

FIG. 14A depicts silver recovery cycles on AC5, according to certain embodiments;

FIG. 14B depicts cycling performance corresponding to FIG. 14A, according to certain embodiments;

FIG. 14C depicts FTIR spectrum of AC5 at the end of 5 cycles, according to certain embodiments; and

FIG. 14D depicts SEM micrograph of AC5 at the end of 5 cycles, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

Aspects of the present disclosure are directed towards a method for recovering metals using a 3D-like Schiff-bridging crown-based material. The 3D-like Schiff-bridging crown-based material, herein referred to as AC5, has numerous interaction centers for the selective recovery of Ag⁺ ions. Through this design, a significant enhancement in the silver ion (Ag⁺) recovery is achieved with excellent removal efficiency up to 99.9%, and a tremendous increase in selectivity of 400,000-900,000% when compared to the group I and II metal ions (Li⁺, Na⁺, K⁺, Mg²⁺ and Ca²⁺) found in seawater, and the heavy metal ions (Cu²⁺, Cd²⁺, Ni²⁺ and Pb²⁺) found in electronic wastes. First principles of density functional theory (DFT) and classical molecular dynamics (MD) simulations reveal that the structural geometry of AC5 favors high charge transfer, lowered global hardness, and enhanced ion-dipole attractions towards Ag⁺ ions, making the material an excellent candidate for the efficient recovery of silver from desalination brine and spent silver resources.

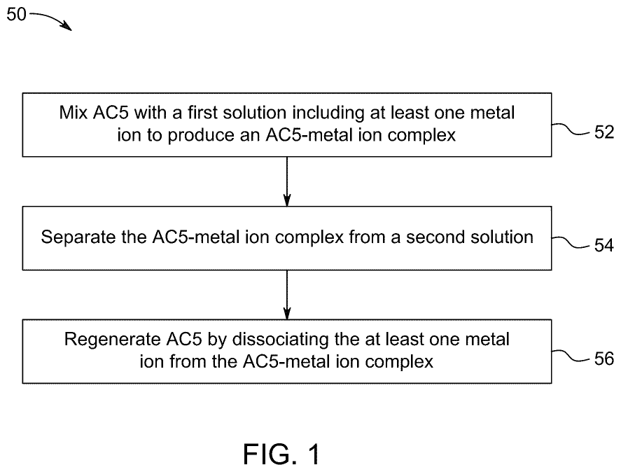

FIG. 1 illustrates a method 50 for recovering metals. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing AC5 with a first solution including at least one metal ion to produce an AC5-metal ion complex. The AC5 is a tris-benzo-15-crown-5 compound. The tris-benzo-15-crown-5 compound includes at least one Schiff base bridge. The tris-benzo-15-crown-5 compound is tris(4-methylbenzyl-4′aminobenzo-15-crown-5 ether) amine. In an embodiment, the AC5 is mixed with the first solution. The first solution includes at least one metal ion. The first solution may be seawater, electronic wastewater, hard water, fresh water, and the like. In an embodiment, the metal salt present in the first solution is silver. The first solution may further include dissolved ions, such as Li⁺, Na⁺, K⁺, Ca²⁺, Cu²⁺, Cd²⁺, Ni²⁺, and or combinations thereof. The first solution may also include one or more salts selected from salts of sodium, magnesium, calcium, potassium, ammonium, and iron, and anions such as chloride, bicarbonate, carbonate, sulfate, sulfite, phosphate, iodide, nitrate, acetate, citrate, fluoride, and nitrite.

In an embodiment, a solid form of AC5 is mixed into a second solution prior to mixing the AC5 in the first solution. The second solution may be an organic solvent. Suitable examples of the organic solvent include dimethyl formamide, hexane, ethanol, isopropanol, dichloromethane, etc. In an embodiment, the first solution and the second solution are immiscible. In an embodiment, the mixing time is in a range of 1-5 hours, preferably 1.5-4 hours, preferably 2-3 hours, preferably 2 hours. The metal ion, preferably silver ion, coordinates to the AC5 at a Φ₂ or Φ₃ position upon mixing to form the AC5-metal ion complex.

The mixing of AC5 in the first solution can be performed ultrasonically for a time range of 8 to 15 minutes, more preferably 9 to 12 minutes, and yet more preferably 10 minutes. The mixing can be performed ultrasonically for a range of 250-350 rotations per minute (rpm), more preferably 280-320 rpm, and yet more preferably 300 rpm for 4 to 8 minutes, more preferably 4.5 to 5.5 minutes, and yet more preferably 5 minutes. As used herein, the term ‘sonication’ refers to the process in which sound waves are used to agitate particles in a solution. In some embodiments, other modes of mixing known to those of ordinary skill in the art, for example, via stirring, swirling, agitation, or a combination thereof may be employed to form the resultant mixture.

At step 54, the method 50 includes separating the AC5-metal ion complex from a second solution. The separation of the AC5-metal ion complex is carried out by filtering the AC5-metal ion complex from the second solution. The various mode of separation may include decantation, evaporation, and using a separating funnel.

At step 56, the method 50 includes regenerating AC5 by dissociating the metal ion from the AC5-metal ion complex. The AC5 is regenerated by mixing a solution preferably including dithizone, an acid, and ethanol with the AC5-metal ion complex. The acid is preferably HCl. In some embodiments, the acid be hydrofluoric acid, citric acid, formic acid, acetic acid, or a mixture thereof. In an embodiment, the AC5 from the AC5-metal ion complex can be regenerated for at least 5 regeneration cycles.

The tris-benzo-15-crown-5 compound has a silver ion distribution coefficient K_{d} greater than 200 liter per gram (L/g) calculated according to the following:

$${K}_{d} ( L / g ) = \frac{{C}_{o} - {C}_{e}}{{C}_{e}} \times \frac{V}{m}$$

where Cₒ, Cₑ, m, and V are the starting metal ion concentration (ppm), the equilibrium concentration of the metal ions (ppm), the mass of AC5 added (g) and the volume of the solution (ml or L). The tris-benzo-15-crown-5 compound has a silver ion uptake capacity of at least 30 milligram per gram (mg/g).

### Examples

The following examples describe and demonstrate exemplary embodiments of the method 50 for recovering herein. The examples are provided solely for the purpose of illustration and are not to be construed as limitations of the present disclosure, as many variations thereof are possible without departing from the spirit and scope of the present disclosure.

### Example 1: Methodology

### Density Functional Theory (DFT) Methodology

To provide insights on the host-guest interactions of the crown-based material and the metal ions, first-principles DFT simulations on Materials Studio, using the Perdew-Burke-Ernzerhof generalized gradient approximation (PBE-GGA) method, was conducted. This method was selected due to its superior description of electronic sub-systems, and even so it provides a decent level of accuracy when studying molecular level interactions. All the structures were geometrically relaxed on the DMol³ module, while enforcing spin-unrestricted command. A self-consistent field (SCF) threshold of 10⁻⁵ hectare (Ha) was imposed to provide an exact self-consistent charge density and to offer variational freedom during the search for the wavefunctions of the vacant states. The maximum force tolerance was set to 2.0×10⁻³ hectare per angstrom (Ha/Å), whereas the energy tolerance was maintained at 1.0×10⁻⁵ Ha. To simulate the aqueous media, the conductor-like screening model (COSMO) was used, and the solvent was chosen as water. The quantum chemical reactivity descriptors such as the electronegativity (χ), global hardness (η) and the electron affinity (EA) were estimated following the DFT-Koopman theorem of the energies of the highest-occupied molecular orbital (E_{HOMO}) and the lowest-unoccupied molecular orbital (E_{LUMO}). The host-guest interaction energies were estimated using the eq:

$${E}_{int} = {E}_{H - G} - ( {E}_{H} + {E}_{G} ) \qquad ( 1 )$$

Where, E_{H-G}, E_{H} and E_{G} represents the free energies of the host-guest complexes, the isolated host molecule, and the isolated guest ions, respectively.

### Molecular Dynamics Simulations

MD simulations were conducted on the Forcite module of Materials Studio, using the universal forcefield (UFF), the choice of which is attributed to its wider coverage of the periodic table and its decent predictions of the geometries and conformational energies of organic molecules, main group elements and metal complexes. Aqueous simulation boxes with dimensions 30×30×30 Å including of the host molecules previously optimized on the DMol³ module, the metal ions, counter ions, and water molecules were constructed and geometrically optimized using the congruent gradient algorithm, followed by equilibration on the NPT ensemble for a duration of 1000 picosecond (ps), at pressure and temperature of 1 bar and 298.15 kelvin (K), respectively. The initial velocities of the molecules were set as random while the timestep during the dynamics simulations was 1×10⁻³ ps. The temperature and pressure were controlled by the Nose-Hoover thermostat and the Berendsen barostat, during which the trajectory frames were output after every 5000 steps. The Ewald summation method was used to treat the long-range Coulombic interactions, whereas the attractive and repulsive interactions were estimated using the Lennard-Jones method at a cutoff range of 18.5 Å. The equilibrated systems were then subjected to NVT dynamics simulations for a duration of 1500 ps while maintaining the same simulation conditions.

The diffusion of the ions through the aqueous systems were estimated by calculating the mean square displacement (MSD) using the eq:

$$MSD = \frac{1}{N} {\sum }_{i = 1}^{N} {\vert {r}_{i} ( t ) - {r}_{i} ( 0 ) \vert}^{2} \qquad ( 2 )$$

Where, N is the number of ions in the system to be averaged, rᵢ(0) and rᵢ(t) the position vector of the i ion at the start and at time t, respectively.

The description of the guest ions in the domain of the host molecule was estimated by conducting pair correlation function (PCF) analysis using the eq:

$${g}_{ab} ( r ) = \frac{V [ {\sum }_{i \neq j} δ ( r - \vert {r}_{ai} - {r}_{bj} \vert ) ]}{( {N}_{a} {N}_{b} - {N}_{ab} ) 4 π {r}^{2} dr} \qquad ( 3 )$$

Where, a and b represent the host molecule and the guest ions, r the distance between them, V the volume of the entire system, and Nₐ and N_{b} the number of particles of a and b, respectively. Others are Nab the number of similar particles of a and b, and rₐᵢ and r_{bj} the 3-dimensional coordinates of a in i and b in j, respectively.

### Experimental Procedure

All the chemicals and reagents were of high purity and used as received without further purifications. The chemicals and reagents include tris(4-formylphenyl)amine, 97%; 4′-aminobenzo-15-crown-5, 97%; N,N-dimethyl formamide (DMF), anhydrous 99.8%; hydrochloric acid, ACS reagent 37% and dichloromethane (DCM), ACS reagents 99.9% and absolute ethanol all purchased from Sigma Aldrich. Other chemicals include dithizone, from central drug house (CDH) chemicals and standard solutions of Ag, Li, Na, K, Mg, Ca, Ni, Cu, Cd and Pb from Fluka chemicals.

### Synthesis and Characterizations

The crown-based material (AC5) was synthesized by the acid-catalyzed nucleophilic addition of tris(4-formylphenyl)amine to 4′-aminobenzo-15-crown-5 as reported previously with slight modifications [B. M. Ahmed, N. A. Rudell, I. Soto, G. Mezei, Reaction of Amines with Aldehydes and Ketones Revisited: Access To a Class of Non-Scorpionate Tris(pyrazolyl)methane and Related Ligands, The Journal of Organic Chemistry 82(19) (2017) 10549-10562—incorporated herein by reference]. 0.186 g (565.9 micromole (pmol)) of tris(4-formylphenyl)amine was added to 10 ml DMF in a round bottomed flask, followed by 3 drops of HCl (37%) and the solution was stirred vigorously at 300 rotations per minute (rpm) for 5 minutes. Thereafter, 0.502 gram (g) (1772 μmol) of 4′-aminobenzo-15-crown-5 was added and the mixture was stirred for 24 hours at room temperature. The resulting brown solid was collected in acetone, vacuum-filtered and dried at 60° C. overnight. Yield: 0.625 g, (91%, based on the reactant weights). Calculated features: chemical formula: C₆₃H₇₂N₁₄O₁₅, molecular weight: 1125.28, m/z: 1124.50 (100.0%), 1125.50 (70.2%), 1126.51 (23.8%), 1127.51 (7.5%), 1126.50 (4.1%), 1128.51 (1.7%), elemental analysis: C, 67.24; H, 6.45; N, 4.98; 0, 21.33.

The morphology of the material was analyzed on JSM-6701F field emission scanning electron microscope (FESEM) (manufactured by JEOL, Musashino Akishima, Tokyo, 196-0021 Japan) fitted with an energy-dispersive X-ray (EDX) spectrometer, and on JEM-2100F field emission transmission electron microscope (FETEM) (manufactured by JEOL, Musashino Akishima, Tokyo, 196-0021 Japan), whereas the diffraction patterns were obtained on a Miniflex-II X-ray diffractometer (manufactured by Rigaku, 2601A, Tengda Plaza, No. 168, Xizhimenwai Ave) using CuKα radiation. The sample was scanned at the rate of 0.03° C./min in the 20 range of 5-80°. FTIR measurements were conducted on Nicolet™ iS5 FTIR spectrometer (manufactured by Thermo Scientific™, 168 Third Avenue, Waltham, MA, USA 02451) in the range of wavenumber 400-4000 per centimeter (cm⁻¹). Thermal gravimetric analysis (TGA) measurements were conducted on SDT Q600 TGA and Differential Scanning Calorimetry (DSC) analyzer, while the elemental analysis was conducted on EA-2400 CHNS/O elemental analyzer (manufactured by Perkin Elmer, Waltham, Massachusetts, U.S. (2021)).

### Recovery Methods

The silver recovery measurements were conducted by placing 20 ml of freshly prepared 30 parts per million (ppm) solution of the metal ions in a glass vial and 5 milligram (mg) of the material was added. The mixture was sonicated for 10 min, and then kept stirring for 2 hours. Thereafter the mixture was left undisturbed for 1 h at the end of which the supernatant solution was collected in a syringe, filtered, and analyzed by Inductively coupled plasma optical emission spectroscopy (ICP-OES). The recovery efficiency (η), the equilibrium uptake capacity (Qₑ) and the distribution coefficient (K_{d}) were estimated using the eq:

$$η ( \% ) = \frac{{C}_{o} - {C}_{e}}{{C}_{o}} \times 100 \qquad ( 4 )$$

$${Q}_{e} ( mg / g ) = ( {C}_{o} - {C}_{e} ) \times \frac{V}{m} \qquad ( 5 )$$

$${K}_{d} ( L / g ) = \frac{{C}_{o} - {C}_{e}}{{C}_{e}} \times \frac{V}{m} \qquad ( 6 )$$

Where, Cₒ, Cₑ, m, and V are the starting metal ion concentration (ppm), the equilibrium concentration of the metal ions (ppm), the mass of AC5 added (g) and the volume of the solution (ml or L), respectively.

Similarly, liquid-liquid extraction was carried out by mixing 10 ml of AC5 dispersed in DCM with 10 ml of freshly prepared 30 ppm solution of the metal ions in a glass vial and stirred at 300 rpm for 2 hours. Thereafter, the mixture was left to settle for 3 hours, and the two layers were collected in a separatory funnel. The aqueous solution was filtered and analyzed for the metal ions using Inductively Coupled Plasma Optical Emission spectroscopy (ICP-OES) and the η(%), Qₑ(mg/g) and K_{d}(L/g) were estimated.

The exhausted materials were regenerated by treatment with a combination of 0.01% dithizone in ethanol and 0.1 M HCl in the ratio (1:1) for 3 h to desorb the adsorbed metal ions and restore the removal capacity. The regenerated materials were dried in the oven at 60° C. overnight and added to another fresh solution of the metal ion to conduct subsequent removal tests. The desorbed metal ions were collected and measured by ICP-OES and the desorption ratio was calculated using the eq:

$$Desorption ratio = \frac{{Q}_{s}}{{Q}_{e}} \qquad ( 7 )$$

Where, Qₛ and Qₑ are the amount of metal ions in the desorbed solution and the amount adsorbed, respectively.

### Results and Discussions

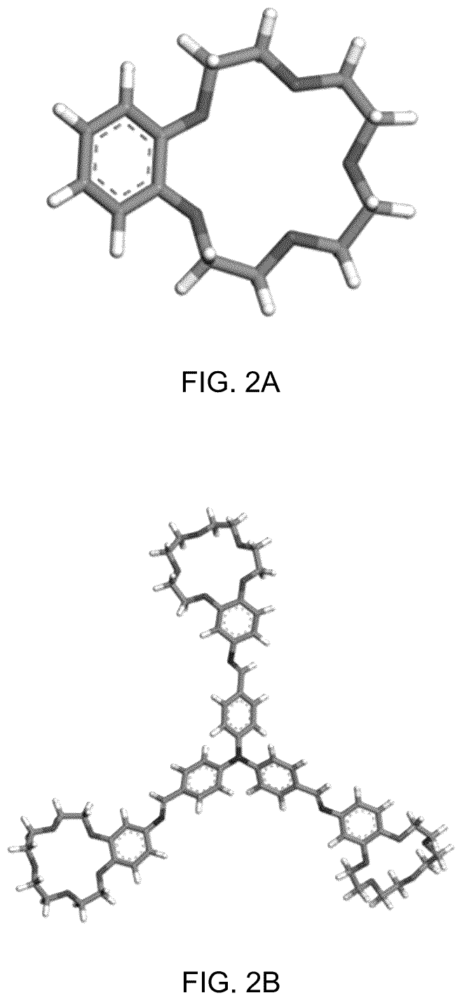

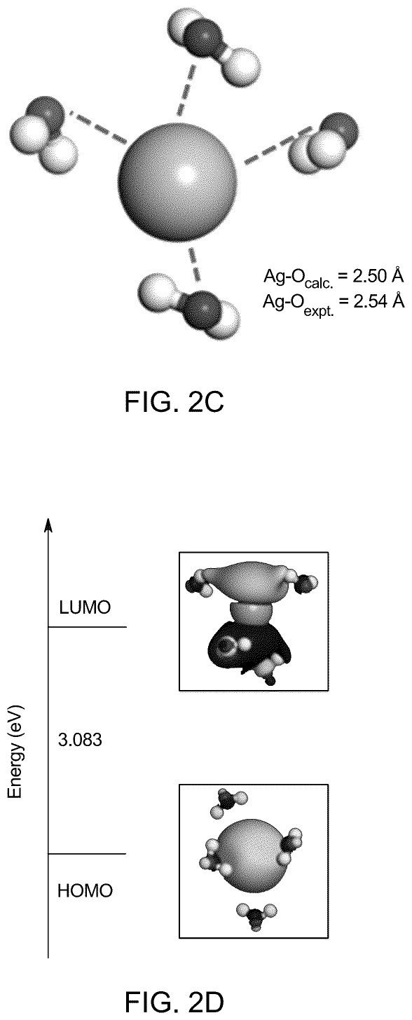

The structural geometries of benzo-15-crown-5 and AC5 are presented in FIGS. 2A-2B. The corresponding structural features are depicted in Table 1. The geometrical structures did not show any implicative variations across all bonds within the crown cavity, implying that the 3D array of the crown ethers in AC5 did not result in structural distortions of the crown moiety. Both molecules exhibit the C1 low symmetry point group, and the bond properties are almost identical. The crown structures remain non-distorted and the intra-atomic bond distances within the crown rings remain almost the same. The energy-minimized aqua-coordinated silver ions, Ag(H₂O)₄⁺ and the corresponding frontier orbital distributions are presented in FIGS. 2C-2D. The hydrated ions displayed the expected coordination numbers and the Mⁿ⁺—O bond distances agreed with experimental findings using the extended X-ray absorption fine structure (EXAFS) and the large-angle X-ray scattering (LAXS) techniques [I. Persson, Hydrated metal ions in aqueous solution: How regular are their structures?, 82(10) (2010) 1901-1917]. The HOMO-LUMO energy gap (ΔE) further revealed that the Ag⁺ ions having the lowest value of 3.083 electron volt (eV) in contrast to the Li⁺, Na⁺, K+, Mg²⁺ and Ca²⁺ ions with the values of 6.732, 6.166, 6.174, 6.136 and 6.234 eV, respectively exhibits high possibility of electronic transitions, high polarizability and stronger back-acceptance of non-bonding electrons when interacting with the crown molecules.

TABLE 1
Calculated bond properties of benzo-15-crown-5
and AC5 at the GGA-PBE level of theory.

| Bond | Benzo-15-crown-5 (Å) | ACS (Å) |
|---|---|---|
| C₁—O₂ | 1.384 | 1.381 |
| O₂—C₃ | 1.474 | 1.474 |
| C₃—C₄ | 1.508 | 1.508 |
| C₄—O₅ | 1.449 | 1.447 |
| O₅—C₆ | 1.452 | 1.450 |
| C₆—C₇ | 1.511 | 1.511 |
| C₇—O₈ | 1.450 | 1.448 |
| O₈—C₉ | 1.450 | 1.448 |
| C₉—C₁₀ | 1.511 | 1.511 |
| C₁₀—O₁₁ | 1.452 | 1.450 |
| O₁₁—C₁₂ | 1.450 | 1.448 |
| C₁₂—C₁₃ | 1.508 | 1.508 |
| C₁₃—O₁₄ | 1.477 | 1.473 |
| O₁₄—C₁₅ | 1.385 | 1.380 |
| C₁₅—C₁ | 1.435 | 1.434 |
| O₂—O₈ | 4.508 | 4.545 |
| O₂—O₁₁ | 4.462 | 4.573 |
| O₅—O₁₄ | 4.546 | 4.443 |
| O₅—O₁₁ | 4.541 | 4.570 |

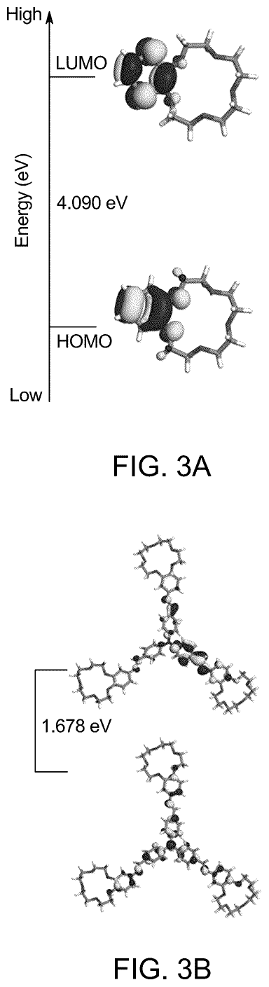

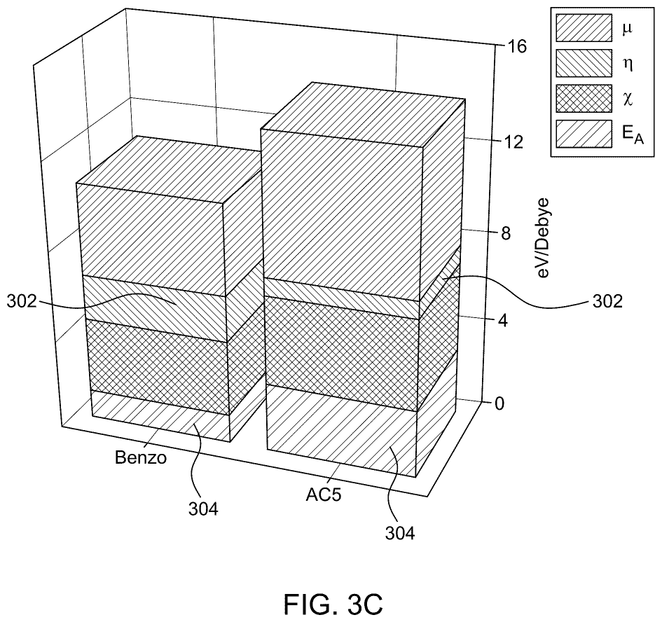

Meanwhile, the frontier orbital distribution and the fundamental electronic properties of the crown molecules are presented in FIGS. 3A-3C. Evidently, the structural orientation of AC5 favors charge transfer processes as the AE value is significantly lowered (1.678 eV) when compared to the benzo-15-crown-5 (4.090 eV). The electronic properties revealed that AC5 having lower global hardness (η) of 0.839 eV and stronger dipole moment (μ) of 6.22 Debye exhibits the matching structural features for the recovery of Ag⁺ ions which equally has the η of 1.541 eV in accordance with the HSAB principle [R. G. Pearson, Absolute electronegativity and hardness: application to inorganic chemistry, Inorganic Chemistry 27(4) (1988) 734-740—incorporated herein by reference]. The benzo-15-crown-5 in contrast recorded η and μ values of 2.045 eV and 4.047 Debye, respectively lowering its attraction for the Ag⁺ ions, and thus making it non-selective in the presence of competing alkali and alkaline earth metal ions. Consequently, AC5 have shown promising aptness for the selective recovery of silver ions from seawater with minimal interference from competing ions.

The preferential centers of interaction of the metal ions on AC5 were characterized and visualized using the molecular electrostatic potential (MEP) maps. MEP is a graphical illustration of the electronic density of the surface of a material [I. Abdulazeez, Size-controllable crown ether-embedded 2D nanosheets for the host-guest ion segregation and recovery: Insights from DFT simulations, Journal of Physics and Chemistry of Solids 171 (2022) 110983]. It predicts the local reactivity on the material surface. Regions of low electron density are characterized by 302 and represent the active centers prone to nucleophilic attack, while the regions of high electron density are depicted by 304 which represents the centers prone to electrophilic interactions. An inspection of the MEP of the molecules revealed that whilst the benzo-15-crown-5 exhibited greater dipole interactions within the crown cavity, three possible interaction centers were identified on AC5; the macrocyclic crown cavity, the sp²-hybridized Schiff nitrogen atoms and tetrahedrally-coordinated sp³ nitrogen atoms on the tris(4-formylphenyl)amine moiety. These centers were identified as Φ₁, Φ₂ and Φ₃, and their preferential interactions with the metal ions were studied.

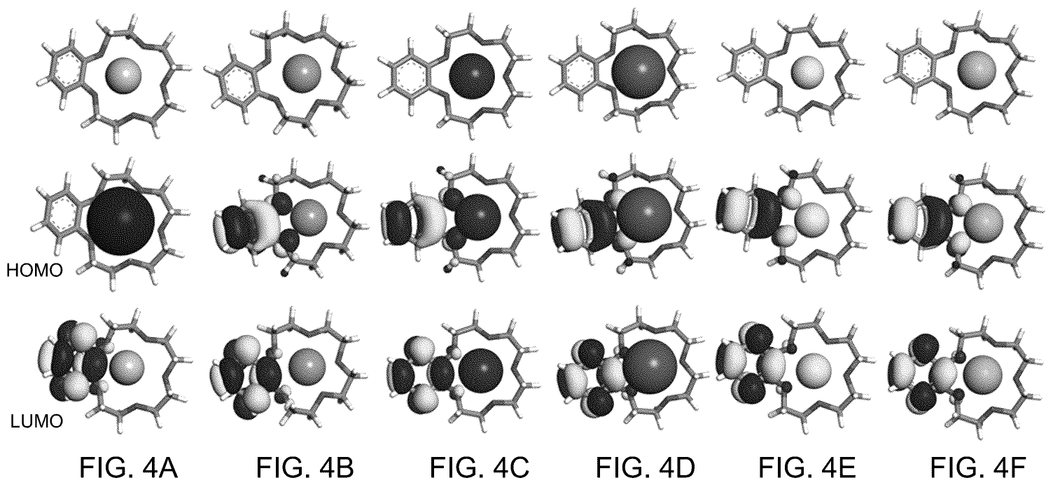

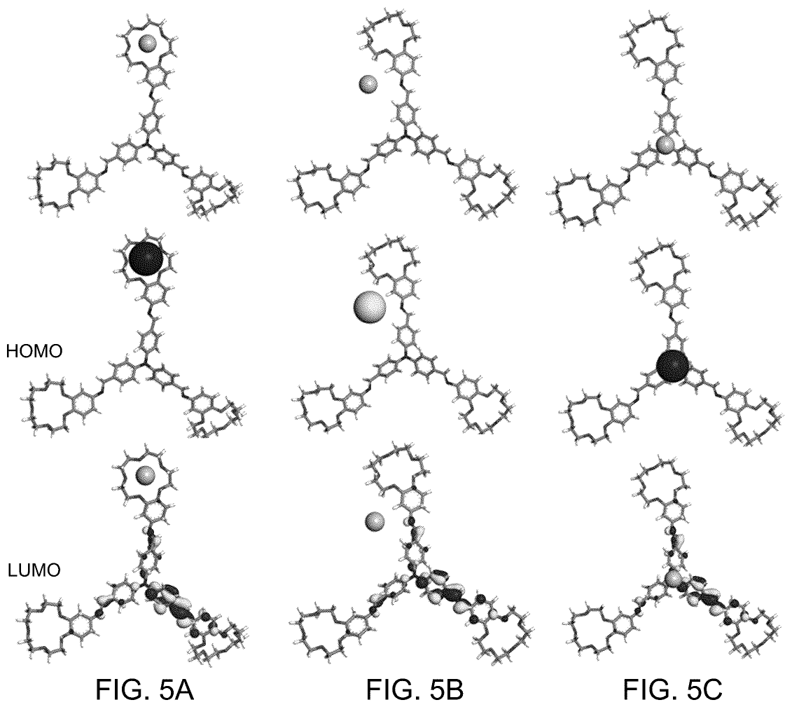

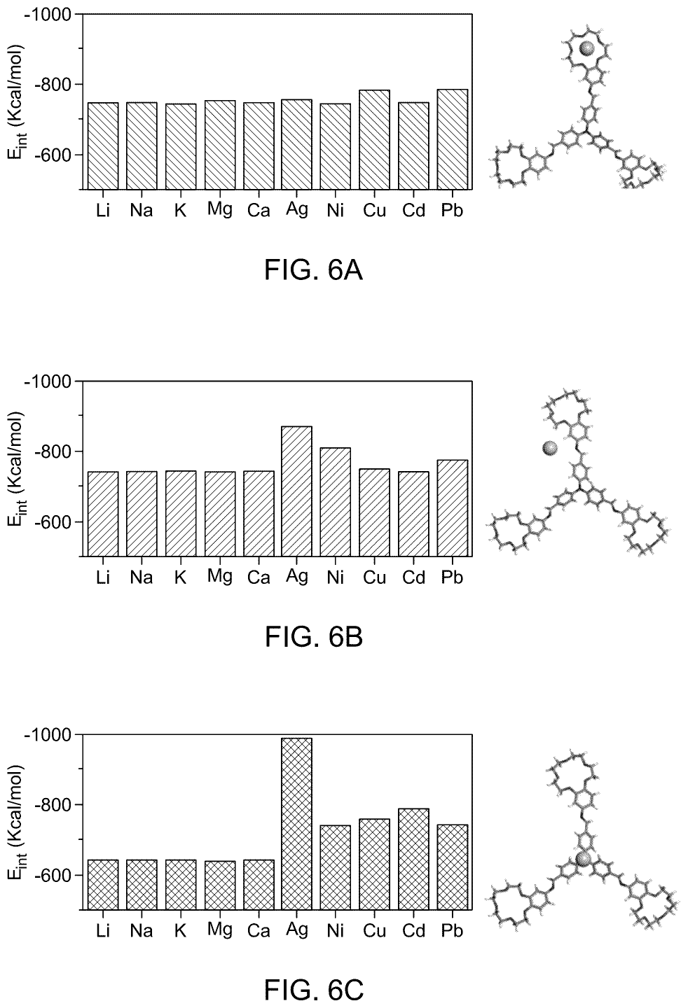

The interactions of both materials with the metal ions in seawater and in e-waste (on AC5 only) using first principles DFT simulations. All the metal ions were placed at 2.5 Å above the crown nanopores on benzo-15-crown-5 and at the Φ₁, Φ₂ and Φ₃ centers on AC5, and allowed to optimize. The results are presented in FIGS. 4A-4F, FIGS. 5A-5C. The respective interaction energies were estimated using Eq. 1 and presented in FIGS. 6A-6C. In the case of the benzo-15-crown-5, the metal ions can be seen encapsulated within the crown cavities due to the ion-dipole attractions by the polyether oxygen atoms. Weaker attractions were exerted on the metal ions due to the qualitative HSAB principle, and in accordance with the ionic radii of the ions. Consequently, interaction energies (Eᵢₙₜ) of −5.60, −32.9, −28.0, −14.3 and −33.7 kilocalorie per mole (kcal/mol) were estimated for Li⁺, Na⁺, K⁺, Mg²⁺ and Ca²⁺ ions, respectively.

The interaction of the metal ions on AC5 in contrast was highly exergonic and yielded many folds higher than those recorded on the crown. This can be attributed to the lowering in the crown hardness and the surge in the dipole moment resulting from the structural modifications. The Φ₁ active center recorded comparable Eᵢₙₜ among the metal ions due to the non-selectivity of the crown units [Y. Tian, W. Chen, Z. Zhao, L. Xu, B. Tong, Interaction and selectivity of 14-crown-4 derivatives with Li+, Na+, and Mg2+ metal ions, Journal of Molecular Modeling 26(4) (2020) 67; Y. Yang, T. Zhao, M.-H. Li, X. Wu, M. Han, S.-C. Yang, Q. Xu, L. Xian, X. Chi, N.-J. Zhao, H. Cui, S. Li, J.-S. Hu, B. Zhang, Y. Jiang, Passivation of positively charged cationic defects in perovskite with nitrogen-donor crown ether enabling efficient perovskite solar cells, Chemical Engineering Journal 451 (2023) 138962]. The Φ₂ and Φ₃ centers on the other hand exhibited increasing selectivity to silver ions due to the increased polarizability imparted by the aromatic benzene rings around the nitrogen atoms. This ultimately lowered the hardness in these regions and promote the dipole attraction towards silver ions. Consequently, Eᵢₙₜ of −870 and −990 kcal/mol were estimated for silver ions at Φ₂ and Φ₃, respectively. These values are indeed highly negative and imply the spontaneity of the adsorption of silver ions on AC5, and the feasibility of silver recovery from seawater and the feasibility of silver recovery from seawater and from e-waste.

The analysis of the non-covalent interactions (NCI) between the metal ions and benzo-15-crown-5 and AC5 further revealed the nature of interactions of the materials with the metal ions. NCI analysis is an index of electron density and its derivatives and enables the visualization of the nature of the intermolecular interactions between two interacting systems [J. Contreras-Garcia, E. R. Johnson, S. Keinan, R. Chaudret, J.-P. Piquemal, D. N. Beratan, W. Yang, NCIPLOT: A Program for Plotting Noncovalent Interaction Regions, Journal of Chemical Theory and Computation 7(3) (2011) 625-632—incorporated herein by reference]. It utilizes the plot of the reduced density gradient (RDG) and the electron density, ρ where:

$$RDG = \frac{1}{2 {( 3 {π}^{2} )}^{1 / 3}} \frac{\vert ∇ ρ \vert}{{ρ}^{4 / 3}} \qquad ( 8 )$$

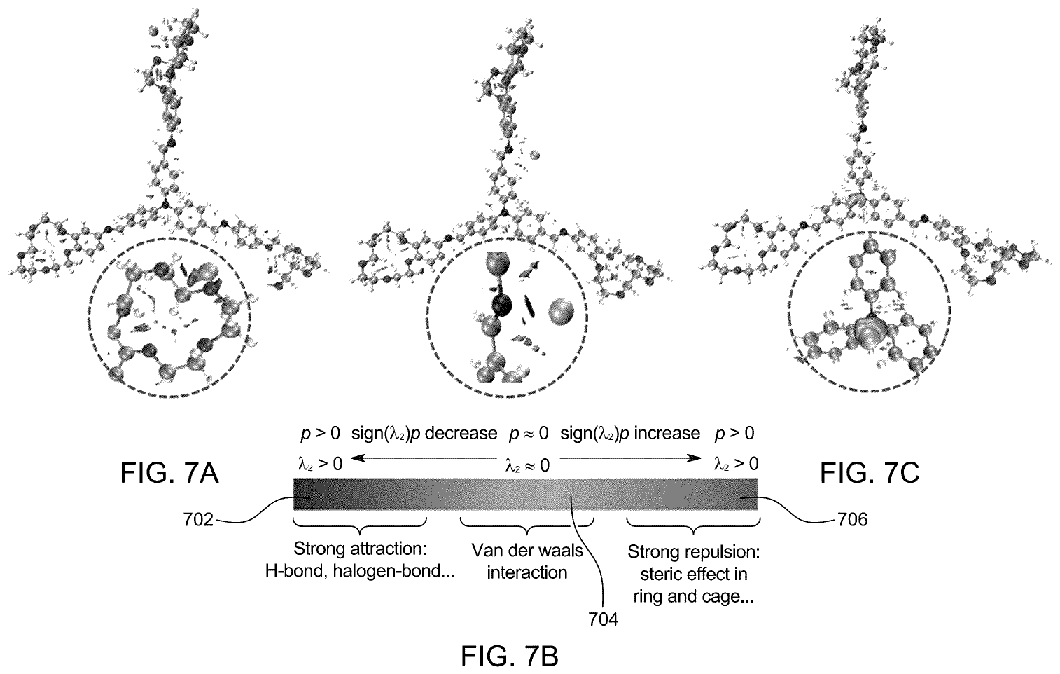

Based on the sign of the electron density (2), the NCI can be classified as either bonded (λ₂<0) or non-bonded (λ₂>0). Consequently, in FIGS. 7A-7C, 702 represents regions of strong attractive interactions, 704 depicts van der Waals interactions, and 706 represents regions of strong repulsive and steric interactions. The NCI iso-surface plots of the interactions of benzo-15-crown-5 with the metal ions revealed that the encapsulation of the metal ions within the crown nanopores was strictly driven by van der Waals attractions with a few instances where the ions experienced repulsions due to steric effect in the vicinity of the rings. Meanwhile on AC5 surface, silver ions were slightly repelled at the Φ₁ and the Φ₂ centers, whereas at Φ₃ position strong van der Waals attraction was experienced enabling the strong binding of the ions (FIGS. 7A-7C). Other metal ions encountered weaker van der Waals interactions at all positions resulting in weaker binding on the AC5 surface. Consequently, AC5 have demonstrated stronger affinity for silver ions in agreement with the estimated interaction energies.

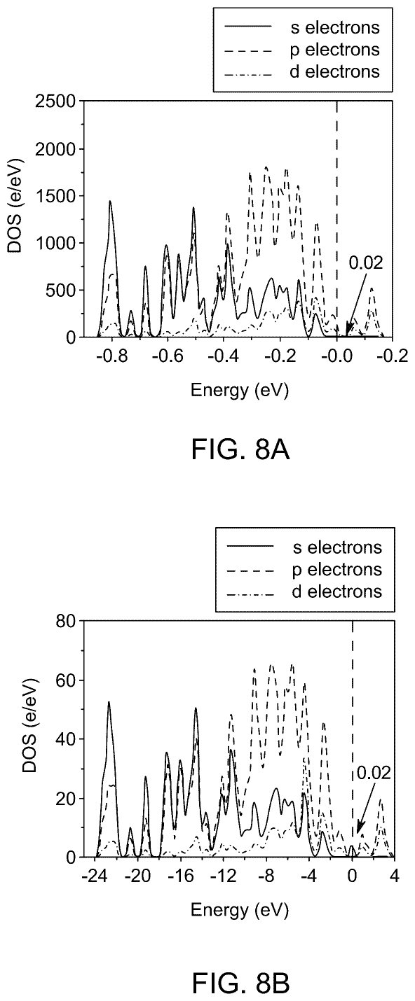

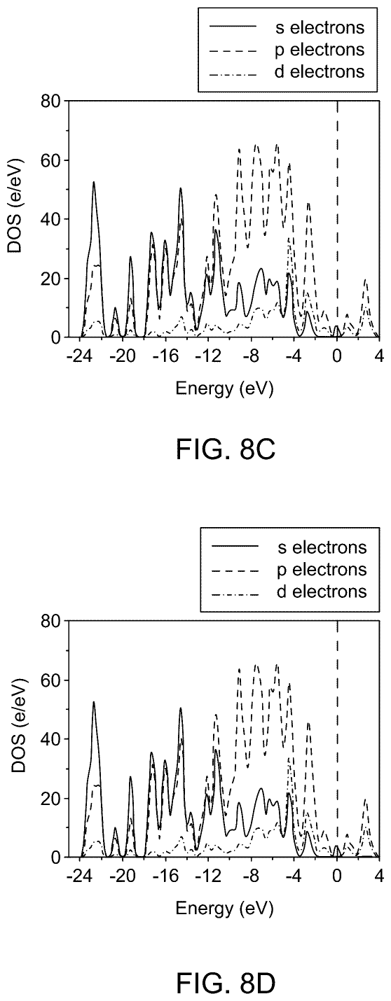

The energetics of electron distribution on the surface of isolated AC5 molecules and during the interactions with the metal ions was further investigated. The partial density of states (PDOS) of the surface atoms of AC5 and the interactions with Ag⁺ ions at the Φ₁, Φ₂ and Φ₃ positions are presented in FIGS. 8A-8D. The PDOS plots revealed an overlap of the Ag s-orbitals with the surface p-orbitals at 0.02 eV (close to the Fermi level), in addition to the significant lowering of the peak intensities. This suggests the hybridization of the orbitals and the subsequent occupation of the states by the s-electrons of Ag. Similarly, the lowering of the band gap near the Fermi level upon interaction with the Ag⁺ ions correspond to the stabilization of the complexes upon interactions. Lastly, the peaks shifted drastically to more negative energies without broadening which was attributed to interactions resulting from non-covalent hybridizations, in agreement with the NCI analysis. Similar drastic shift in energies and lowering of peak intensities were observed in the interactions of AC5 with other metal ions, both in seawater, and in e-waste. However, the non-appearance of the hybrid peak at 0.02 eV in these complexes signifies their weak interactions with AC5. Consequently, PDOS analysis further strengthen the interaction energies and the NCI analysis.

### MD Simulations

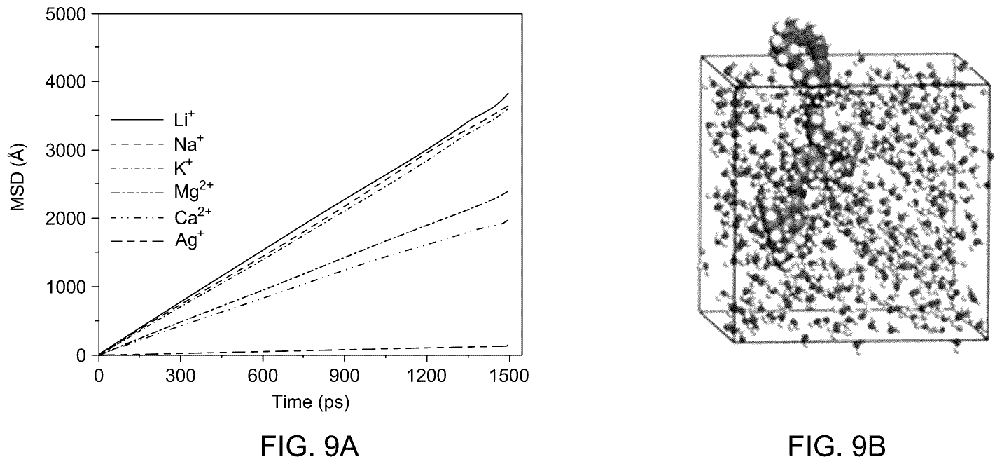

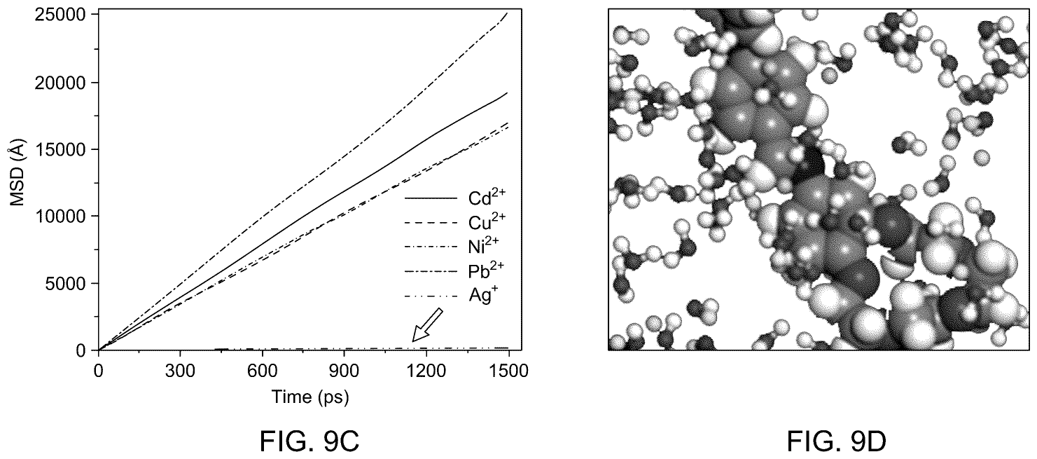

The diffusion of the ions in aqueous systems including of AC5 were studied using classical MD simulations. Amorphous cells including of AC5 molecules, water molecules and the metal ions were constructed and subjected to dynamics simulations on the NVT ensemble. The mean square displacement (MSD) of the diffusion of the ions is presented in FIGS. 9A-9D. The group I and II metal ions experienced minimal electrostatic attractions by the AC5 molecules, resulting in faster diffusion in the aqueous system (FIG. 9A). Similarly, the heavy metal ions (FIG. 9C) due to their weak polarizabilities tend to encapsulate within the crown cavities but are not favorably captured due to their respective ionic sizes. This in turn weakens their interactions with AC5, promoting their fast diffusion. The Ag⁺ ions on the other hand, preferentially interacts at the Φ₂ and Φ₃ centers on AC5 via electrostatic attractions, slowing down their diffusion. Furthermore, the hydrated Ag⁺ ions can be seen undergoing partial dehydration to shed their water molecules and bind strongly.

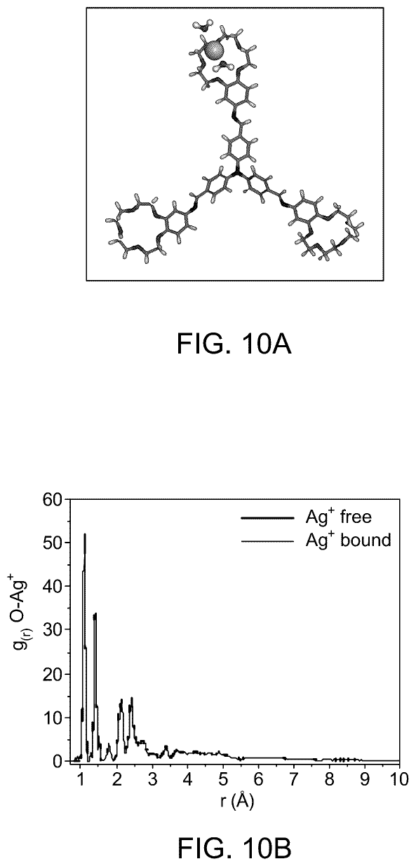

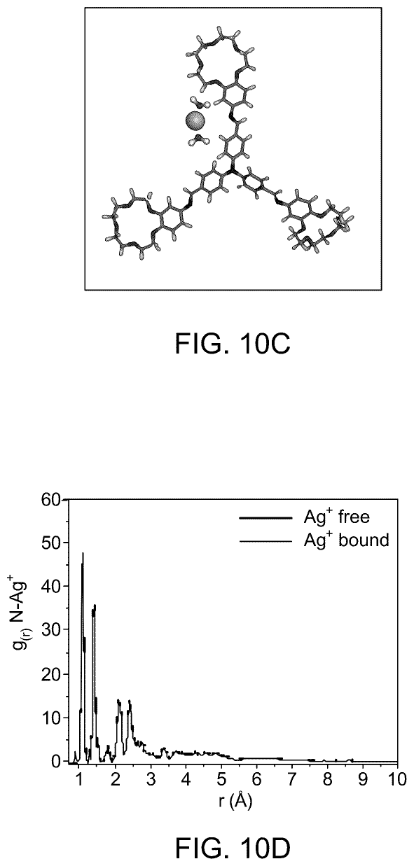

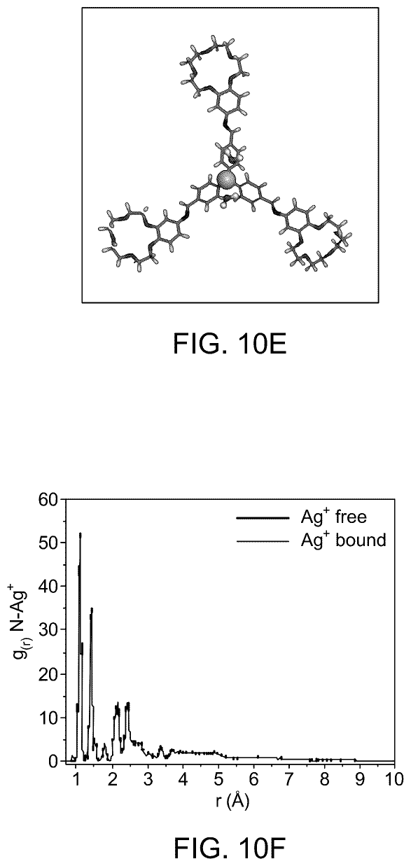

The radial distribution function (RDF) analysis was conducted to illustrate the extent of the interaction of Ag⁺ ions in bulk solution and upon dehydration and interacting with the active centers of AC5. The results are presented in FIGS. 10A-10F. A sharp peak was observed at 1.06 Å indicating strong electrostatic attractions between the material and Ag⁺ ions, in line with the hydration shell of the ions [Y. Zhu, Y. Ruan, Y. Zhang, Y. Chen, X. Lu, L. Lu, Mg2+-Channel-Inspired Nanopores for Mg2+/Li+ Separation: The Effect of Coordination on the Ionic Hydration Microstructures, Langmuir 33(36) (2017) 9201-9210; J. Blumberger, L. Bernasconi, I. Tavernelli, R. Vuilleumier, M. Sprik, Electronic Structure and Solvation of Copper and Silver Ions: A Theoretical Picture of a Model Aqueous Redox Reaction, Journal of the American Chemical Society 126(12) (2004) 3928-3938]. Others are the peaks at 1.49, 1.80, 2.15, 2.50 and 3.45 Å, corresponding to the close-range interactions between the active centers and the ions. Beyond 4.0 Å, the peaks eventually flatten due to the solvation of the active centers. The partially hydrated systems exhibit similar behavior with a slight decrease in intensity, affirming the lability of the coordinated water molecules. These observations further attest the stronger ion-dipole attractions exerted by AC5 on Ag⁺ ions, and the potential of the material for the practical recovery of silver from seawater and e-waste.

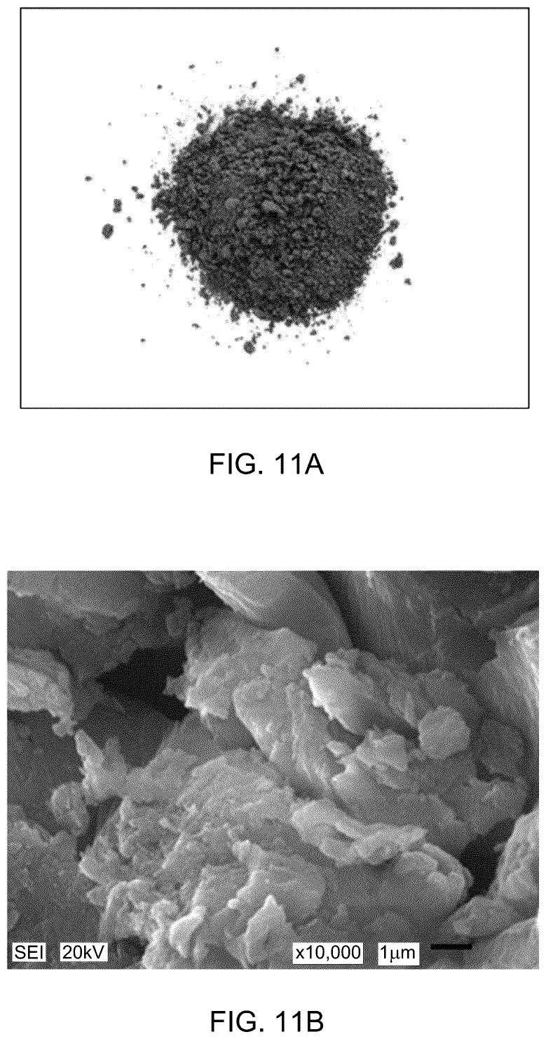

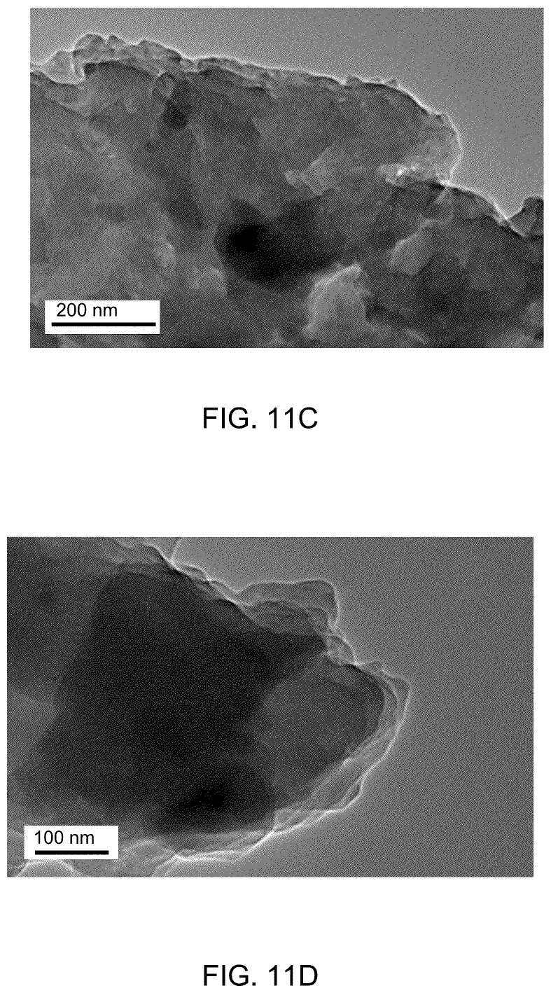

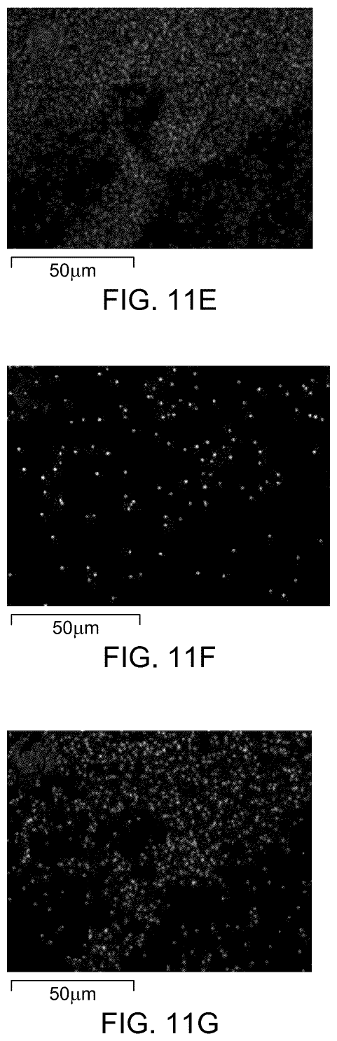

Having established from first principles DFT and classical MD simulations that AC5 exhibit the potential for the practical recovery of silver ions, the next step was to synthesize the material following the procedure in the literature [B. M. Ahmed, N. A. Rudell, I. Soto, G. Mezei, Reaction of Amines with Aldehydes and Ketones Revisited: Access To a Class of Non-Scorpionate Tris(pyrazolyl)methane and Related Ligands, The Journal of Organic Chemistry 82(19) (2017) 10549-10562], with slight modifications. Brownish non-crystalline powder having flake-like morphologies with irregular sizes was obtained (FIGS. 11A-11B). The TEM images revealed the flake-like materials stacked above each other and the nanopores of the crown rings depicted as dark regions (FIGS. 11C-11D). The elemental mapping of the surface of AC5 (FIGS. 11E-11G) revealed the distribution of carbon, nitrogen, and oxygen atoms.

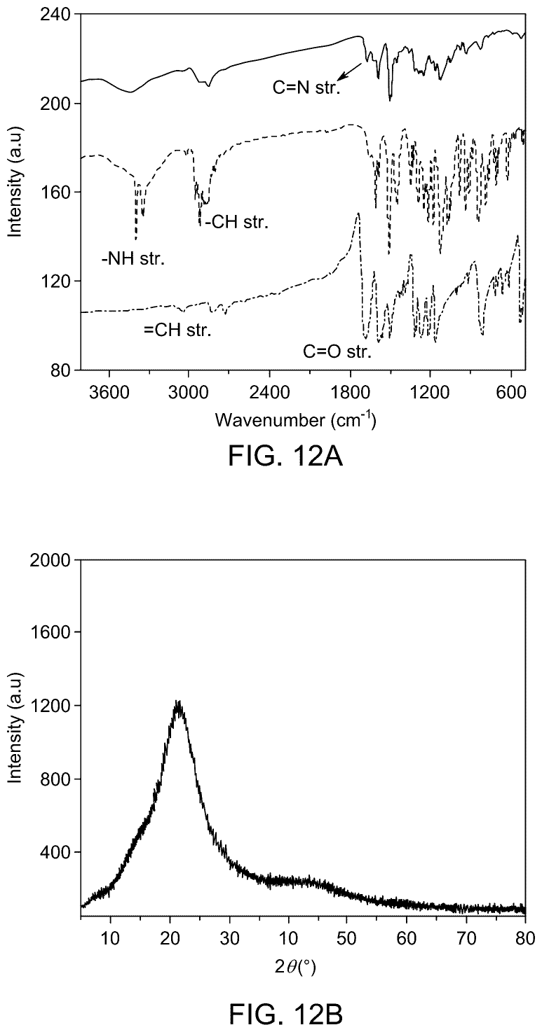

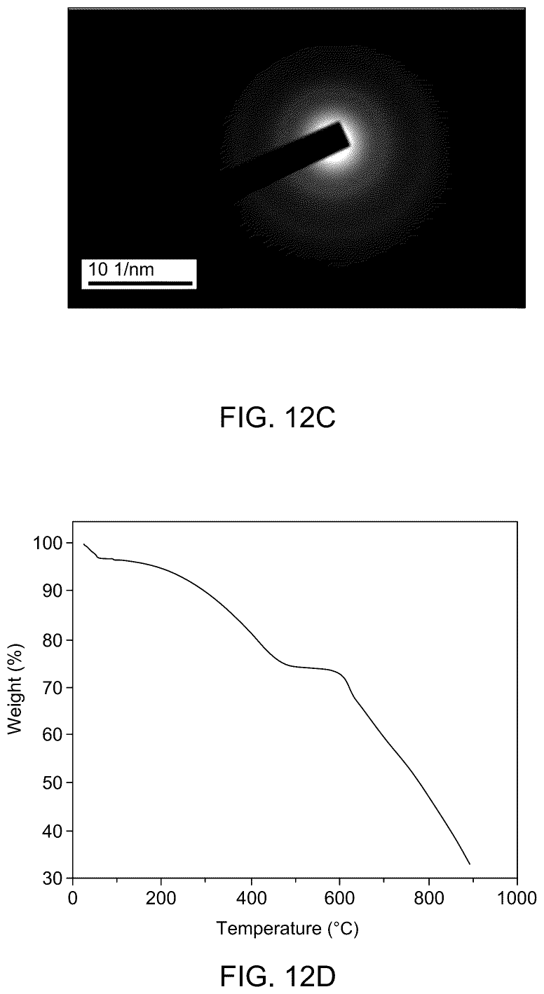

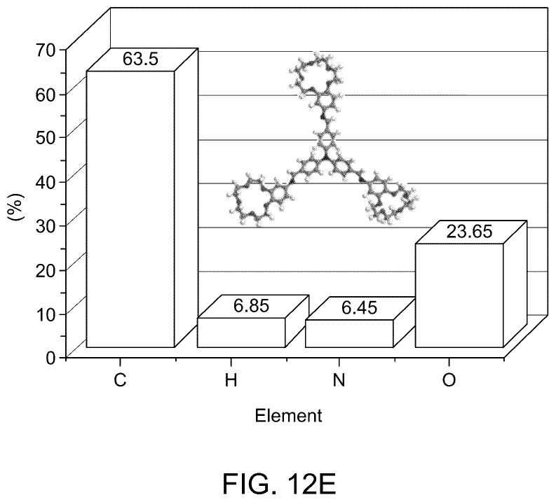

The FTIR spectra of the starting monomers (4′-aminobenzo-15-crown-5 and tris(4-formylphenyl)amine) and AC5 are presented in FIG. 12A. The peak corresponding to the —C═O vibrational stretch can be seen at 1720 cm⁻¹ on tris(4-formylphenyl)amine. This peak is however absent on AC5 confirming the successful protonation and subsequent condensation of the carbonyl oxygen. The primary amine —NH stretch on 4′-aminobenzo-15-crown-5 appeared at 3450 cm-1 which is absent on AC5. The appearance of a weak peak at 1690 cm⁻¹ on the spectrum of AC5 corresponding to the imine —C═N stretch, and the disappearance of the —NH stretch band affirms the successful addition of the two monomers via the imine linkage to form the 3D Schiff-bridging crown-based material. The appearance of the broad —OH peak at 3500 cm⁻¹ could be attributed to the partial protonation of the oxygen atoms within the crown macrocyclic cavity. The X-ray diffraction (XRD) and selected area electron diffraction (SAED) spectra of AC5 (FIGS. 12B-12C) revealed its non-crystalline nature, with pattern typical of amorphous materials. The thermogravimetric analysis (TGA) profile (FIG. 12D) revealed two major weight loss at 300° C. and 650° C., which correspond to the combustion of fractions of the molecule with the release of NOx, CO₂, and H₂O, respectively. The elemental analysis (FIG. 12E) identified the constituent elements of AC5 to be carbon, hydrogen, nitrogen, and oxygen with the percent weight of 63.05, 6.85, 6.45 and 23.65%, respectively.

### Silver Recovery

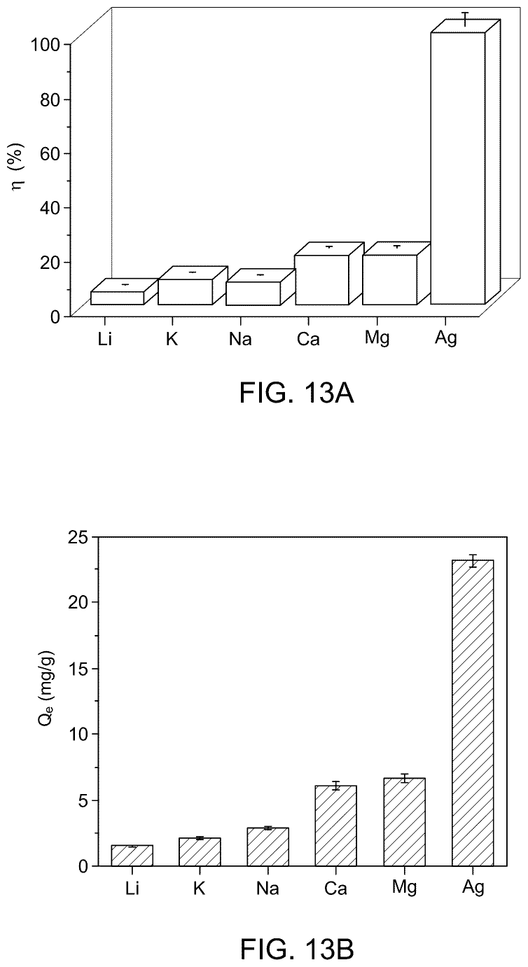

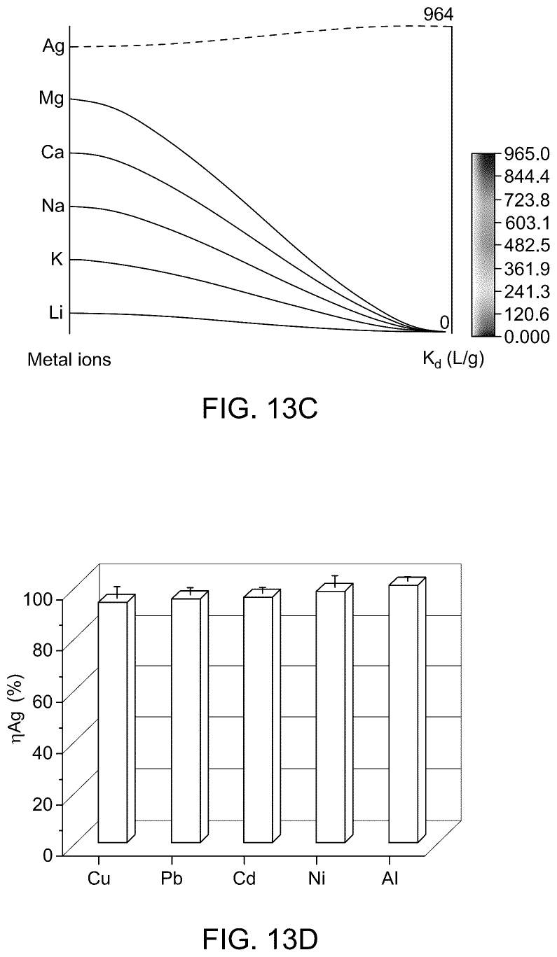

The recovery of silver ions using AC5 was conducted in simulated seawater include Li⁺, Na⁺, K⁺, Mg²⁺ and Ca²⁺ ions and the results are presented in FIG. 13A-13C. The structural geometry of AC5 lowers the hardness and promotes the affinity for Ag⁺ ions. The relatively harder groups I and II ions were weakly attracted towards the active centers, resulting in lower removal efficiency. AC5 thus, achieved 99.9% removal of Ag⁺ ions, while the groups I and II ions such as Li⁺, Na⁺, K⁺, Mg²⁺ and Ca²⁺ ions recorded efficiencies of 4.61, 8.13, 9.09, 18.3 and 18.1%, respectively (FIG. 13A). The equilibrium uptake capacity (Qₑ) measured for each ion (FIG. 13B) put silver ahead with a value of 23.1 milligram per gram (mg/g), in contrast to the values of 1.50, 2.81, 2.13, 6.62 and 6.11 mg/g achieved for Li⁺, Na⁺, K⁺, Mg²⁺ and Ca²⁺ ions, respectively. While the Qₑ may not be significantly high, the corresponding distribution coefficients (K_{d}) of AC5 for the metal ions (FIG. 13C) shows the extreme selectivity of the material towards Ag⁺ ions. Thus, K_{d} values of 0.048, 0.088, 0.100, 0.225 and 0.221 liter per gram (L/g) were measured for Li⁺, Na⁺, K⁺, Mg²⁺ and Ca²⁺ ions, respectively. The Ag⁺ ions in contrast achieved a remarkable K_{d} of 964.3 L/g, up to 900,000% higher in selectivity than the groups I and II ions. Similar results were achieved with liquid-liquid extractions using dichloromethane. In the presence of the common heavy metal ions Cu²⁺, Pb²⁺, Cd²⁺ and Ni²⁺ present in e-wastes, AC5 further achieved and excellent recovery of Ag⁺ ions, maintaining the removal efficiency of 99.9% (FIG. 13D), uptake capacity up to 30.1 mg/g and K_{d} of 791.2 L/g. These results agree with the predicted reactivity of AC5 from DFT and MD simulations and demonstrate the extreme selectivity of AC5 to Ag⁺ ions, making it a potential material for the practical recovery of silver from seawater and electronic wastes.

### Desorption and Regeneration

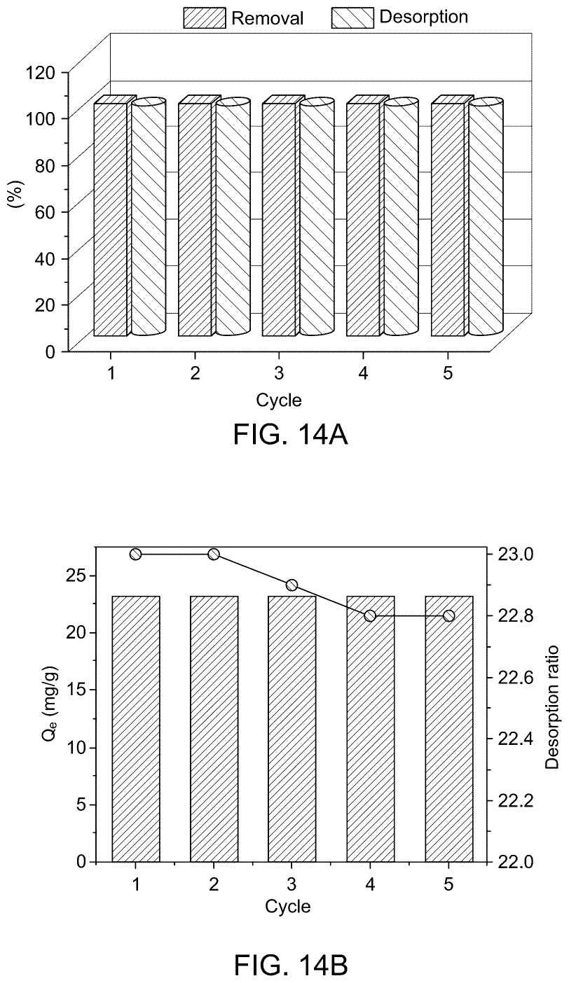

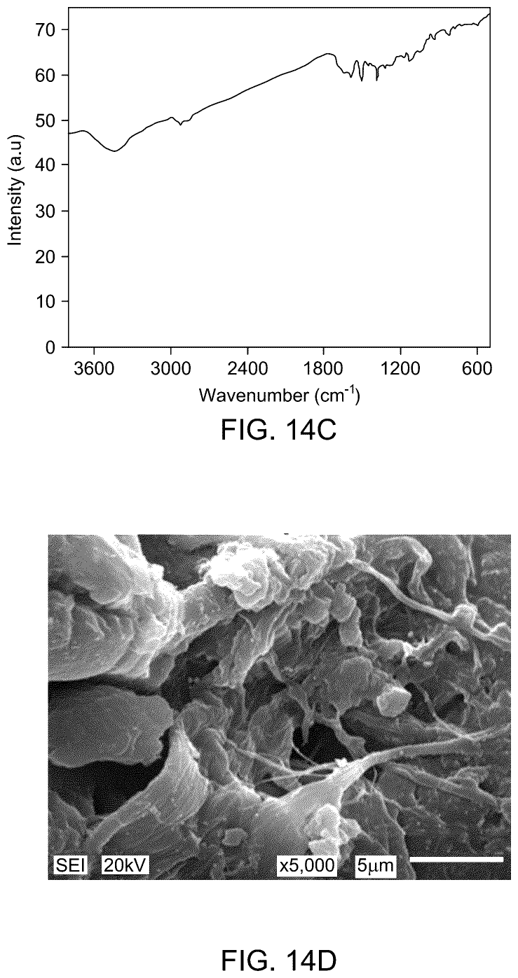

The desorption and regeneration of adsorbents is essential to their practical applications. Thus, the desorption of the recovered silver ions in the present disclosure in a 1:1 v/v solution of 0.01% dithizone in ethanol and 0.1 M HCl was conducted. While the acid weakens the interactions of the AC5 with Ag⁺ ions by the partial protonation of the adsorbent, the sulfur-containing dithizone chelates with the ions to form metal-dithizone complex [H. Tavallali, G. Deilamy-Rad, A. Parhami, S. Z. Mousavi, A novel development of dithizone as a dual-analyte colorimetric chemosensor: Detection and determination of cyanide and cobalt (II) ions in dimethyl sulfoxide/water media with biological applications, Journal of Photochemistry and Photobiology B: Biology 125 (2013) 121-130; L. L. A. Ntoi, B. E. Buitendach, K. G. von Eschwege, Seven Chromisms Associated with Dithizone, The Journal of Physical Chemistry A 121(48) (2017) 9243-9251; S. Srisung, N. Wasukan, M. Kuno, S. Somsri, N. Tanjedrew, Raman enhanced scattering and DFT studies on the adsorption behaviour of dithizone on silver nanoparticle, Inorganic Chemistry Communications 126 (2021) 108480]. Further acidification of these complexes releases the Ag⁺ ions which can then be collected and the AC5 is regenerated with thorough washing in slightly alkaline solution (pH 9) and re-used. As shown in FIG. 14A, the regenerated AC5 exhibited negligible loss in capacity and maintained the recovery >99% even after 5 cycles of removal-regeneration. The desorption efficiency was also maintained >95%, making the regeneration strategy an effective one. Meanwhile, the uptake capacity and the desorption ratio (FIG. 14B) were excellently maintained with no significant decline in recyclability after 5 consecutive cycles. Lastly, the structural features of the regenerated AC5 molecules were checked by conducting FTIR and SEM analysis (FIGS. 14C-14D). The results showed that the structural features were retained as all the peaks on the original material were present, and the structural morphology was retained, suggesting the recyclability.

Silver Recovery from Real Seawater

The potential of the practical utilization of AC5 for silver recovery from seawater and other aqueous sources was investigated on real seawater samples collected from the sea front in Khobar, Eastern province of Saudi Arabia. The sample was filtered using fine acid-treated filter paper and the silver content was analyzed using ICP-OES. The measured Ag⁺ ions concentration was 5.67 parts per billion (ppb). The sample was further spiked with 1000 ppb of standard Ag⁺ ions and both the un-spiked and the spiked samples were added to a pre-weighed amount of AC5 and subjected to the recovery process. Interestingly AC5 achieved remarkable recovery of Ag⁺ ions in both samples (Table 2) reaching the efficiency of 97.4 and 96.8%. These results validate the predicted change in structural behavior of the crown molecules and demonstrate the extreme selectivity of AC5 to Ag⁺ ions in a complex matrix such as the seawater. Meanwhile, the performance comparison among related materials from the literature (Table 3) showed that AC5 outperform other crown and non-crown-based materials in the selectivity towards silver ions.

TABLE 2
The recovery of silver in practical seawater using AC5

| | Ag concentration (ppb) | | |
|---|---|---|---|
| Sample | Before | After | η (%) |
| Seawater | 5.670 | 0.148 | 97.4 |
| Spiked | 959.1 ± 0.23 | 30.88 | 96.8 |

TABLE 3
Performance comparison among related materials

| | | | | Feed | | |
|---|---|---|---|---|---|---|
| Material | η (%) | Qₑ (mg/g) | K_{d} (L/g) | concentration | | Ref |
| 18-crown-6 | 93.6 | 46.1 | 150 | 10-80 | mg/L | [M. Hong, X. Wang, W. |
| functionalized | | | | | | You, Z. Zhuang, Y. Yu, |
| mesoporous silica | | | | | | Adsorbents based on crown |
| | | | | | | ether functionalized |
| | | | | | | composite mesoporous |
| | | | | | | silica for selective |
| | | | | | | extraction of trace silver, |
| | | | | | | Chemical Engineering |
| | | | | | | Journal 313 (2017) 1278- |
| | | | | | | 1287] |
| 18-crown-6- | 96 | — | — | 0.13 | mmol | [Y. Yi, Y. Wang, H. Liu, |
| crosslinked | | | | | | Preparation of new |
| chitosan | | | | | | crosslinked chitosan with |
| | | | | | | crown ether and their |
| | | | | | | adsorption for silver ion for |
| | | | | | | antibacterial activities, |
| | | | | | | Carbohydrate Polymers |
| | | | | | | 53(4) (2003) 425-430] |
| Diaza-18-crown-6 | — | 157.8 | 31.7 | 30 | mg/L | [S. Ding, X. Zhang, X. |
| chitosan | | | | | | Feng, Y. Wang, S. Ma, Q. |
| | | | | | | Peng, W. Zhang, Synthesis |
| | | | | | | of N,N′-diallyl dibenzo 18- |
| | | | | | | crown-6 crown ether |
| | | | | | | crosslinked chitosan and |
| | | | | | | their adsorption properties |
| | | | | | | for metal ions, Reactive |
| | | | | | | and Functional Polymers |
| | | | | | | 66(3) (2006) 357-363.] |
| Molecular-ion- | — | 18.0 | 3.95 | 10 | mg/L | [X. Song, C. Li, R. Xu, K. |
| imprinted | | | | | | Wang, Molecular-Ion- |
| chitosan | | | | | | Imprinted Chitosan |
| | | | | | | Hydrogels for the Selective |
| | | | | | | Adsorption of Silver(I) in |
| | | | | | | Aqueous Solution, |
| | | | | | | Industrial & Engineering |
| | | | | | | Chemistry Research 51(34) |
| | | | | | | (2012) 11261-11265] |
| Dicyclohexano- | 96 | — | — | 10 | mg/L | [C.T. Camagong, T. Honjo, |
| 18-crown-6 | | | | | | Use of dicyclohexano-18- |
| | | | | | | crown-6 to separate traces |
| | | | | | | of silver(I) from potassium |
| | | | | | | thiocyanate in hydrochloric |
| | | | | | | acid media, and |
| | | | | | | determination of the silver |
| | | | | | | by atomic absorption |
| | | | | | | spectrometry, Analytical |
| | | | | | | and Bioanalytical |
| | | | | | | Chemistry 373(8) (2002) |
| | | | | | | 856-862] |
| Organic resin | — | 3333.3 | — | 200 | mg/L | [Z. çelik, M. Gulfen, A. O. |
| | | | | | | Aydm, Synthesis of a novel |
| | | | | | | dithiooxamide- |
| | | | | | | formaldehyde resin and its |
| | | | | | | application to the |
| | | | | | | adsorption and separation |
| | | | | | | of silver ions, Journal of |
| | | | | | | Hazardous Materials |
| | | | | | | 174(1) (2010) 556-562] |
| Coffee beads | 95 | 36.3 | — | 50 | mg/L | [C. Jeon, Adsorption and |
| | | | | | | recovery of immobilized |
| | | | | | | coffee ground beads for |
| | | | | | | silver ions from industrial |
| | | | | | | wastewater, Journal of |
| | | | | | | Industrial and Engineering |
| | | | | | | Chemistry 53 (2017) 261- |
| | | | | | | 267] |
| Magnetic reduced | 84.2 | — | — | 4 | μg/L | [L. Luo, Y. Yang, H. Li, R. |
| graphene oxide | | | | | | Ding, Q. Wang, Z. Yang, |
| | | | | | | Size characterization of |
| | | | | | | silver nanoparticles after |
| | | | | | | separation from silver ions |
| | | | | | | in environmental water |
| | | | | | | using magnetic reduced |
| | | | | | | graphene oxide, Science of |
| | | | | | | The Total Environment |
| | | | | | | 612 (2018) 1215-1222] |
| Magnetic | 97 | 166 | — | 50 | μg/L | [M.H. Beyki, M. Bayat, S. |
| cellulose xanthate | | | | | | Miri, F. Shemirani, H. |
| | | | | | | Alijani, Synthesis, |
| | | | | | | Characterization, and |
| | | | | | | Silver Adsorption Property |
| | | | | | | of Magnetic Cellulose |
| | | | | | | Xanthate from Acidic |
| | | | | | | Solution: Prepared by One |
| | | | | | | Step and Biogenic |
| | | | | | | Approach, Industrial & |
| | | | | | | Engineering Chemistry |
| | | | | | | Research 53(39) (2014) |
| | | | | | | 14904-14912] |
| Amino- | 83.9 | 15.14 | — | 50-1000 | mg/L | [L. A. Romero-Cano, H. |
| functionalized | | | | | | Garcia-Rosero, M. del |
| organic matrix | | | | | | Olmo-Iruela, F. Carrasco- |
| | | | | | | Marin, L.V. Gonzalez- |
| | | | | | | Gutierrez, Amino- |
| | | | | | | functionalized material |
| | | | | | | from a bio-template for |
| | | | | | | silver adsorption: process |
| | | | | | | evaluation in batch and |
| | | | | | | fixed bed, 94(2) (2019) |
| | | | | | | 590-5991 |
| 3D 15-crown-5 | 99.9 | 23.1 | 964.3* | 30 | mg/L | The present disclosure |
| Schiff base (AC5) | | | | | | |

*The highest reported in the literature.

In the present disclosure, the potential of the practical recovery of silver from seawater and e-waste on a novel 3D-like Schiff-bridging crown-based material (AC5) was studied. First principles DFT and classical MD simulations revealed that AC5 exhibited high charge transfer efficacy, sufficient binding sites, lowered global hardness and significantly enhanced ion-dipole attractions towards Ag⁺ ions. It was demonstrated that in the presence of groups I and II metal ions (Li⁺, Na⁺, Mg²⁺, Ca²⁺, and K⁺) found in seawater, AC5 achieved excellent recovery of Ag⁺ ions with removal efficiency of up to 99.9%, and a tremendous selectivity of 400,000-900,000%. In the presence of heavy metal ions (Cu²⁺, Cd²⁺, Ni²⁺ and Pb²⁺) found in electronic wastes however, the novel material achieved remarkable selectivity with the removal efficiency in the range 94-99.9%. The present disclosure reports a strategy for the rational design of effective materials for silver recovery from seawater and spent silver sources, a strategy that could be further explored for a sustainable brine economy.

Numerous modifications and variations of the present disclosure are possible in light of the above teachings. It is therefore to be understood that within the scope of the appended claims, the invention may be practiced otherwise than as specifically described herein.

1. A method for recovering silver, the method comprising:
mixing AC5 with a first solution comprising silver ions to produce an AC5-silver ion complex;
separating the AC5-silver ion complex from a second solution; and
regenerating AC5 by dissociating the silver ion from the AC5-silver ion complex to recover the silver;
wherein AC5 is a tris-benzo-15-crown-5 compound.

2. The method according to claim 1, wherein the tris-benzo-15-crown-5 compound comprises at least one Schiff base bridge.

3. The method according to claim 1, wherein the tris-benzo-15-crown-5 compound is tris(4-methylbenzyl-4′aminobenzo-15-crown-5 ether) amine.

4. The method according to claim 1, wherein the silver ion in Ag⁺.

5. The method according to claim 1, wherein the first solution is sea water.

6. The method according to claim 1, wherein the first solution is electronic wastewater.

7. The method according to claim 1, wherein the tris-benzo-15-crown-5 compound has a silver ion distribution coefficient K_{d} greater than 200 liter per gram (L/g) calculated according to the following:
$${K}_{d} ( L / g ) = \frac{{C}_{o} - {C}_{e}}{{C}_{e}} \times \frac{V}{m}$$
where Cₒ, Cₑ, m, and V are the starting silver ion concentration (ppm), the equilibrium concentration of the silver ions (ppm), the mass of AC5 added (g) and the volume of the solution (ml or L).

8. The method according to claim 1, comprising at least 5 regeneration cycles.

9. The method according to claim 1, wherein the AC5 is regenerated by mixing a solution comprising dithizone, an acid, and ethanol with the AC5-silver ion complex.

10. The method according to claim 9, wherein the acid is HCl.

11. The method according to claim 1, wherein mixing AC5 with the first solution comprises mixing the AC5 in solid form with the second solution.

12. The method according to claim 1, wherein mixing AC5 with the first solution comprises mixing a solution comprising the AC5 with the second solution, wherein the solution comprising the AC5 is immiscible with the second solution.

13. The method according to claim 12, wherein the solution comprising AC5 comprises dichloromethane as a solvent.

14. The method according to claim 1, wherein the mixing has a mixing time greater than or equal to 2 hours.

15. The method according to claim 14, wherein the mixing time is 2 hours.

16. The method according to claim 1, wherein the mixing includes ultrasonically mixing the AC5 and the first solution.

17. The method according to claim 1, wherein the separation of the AC5-silver ion complex further comprises filtering the AC5-silver ion complex from the second solution.

18. The method according to claim 1, wherein the silver ion coordinates to the AC5 at a Φ₂ or Φ₃ position.

19. The method according to claim 1, wherein the tris-benzo-15-crown-5 compound has a silver ion uptake capacity of at least 30 milligram per gram (mg/g).

20. The method according to claim 1, wherein the first solution further includes dissolved ions Li⁺, Nₐ⁺, K⁺, Ca²⁺, Cu²⁺, Cd²⁺, and Ni²⁺.
